(19) United States
(12) Patent Application Publication
(10) Pub. No.: US 2009/0056180 A1
(43) Pub. Date: Mar. 5, 2009

(54) SOAP BUBBLE FOUNTAIN

(75) Inventors: Sheldon LEVINSON, San Diego, CA (US); Daniel Lee BIZZELL, Davidson, NC (US); Kevin DAHLQUIST, Charlotte, NC (US); Carole RUFFIN, Charlotte, NC (US)

Correspondence Address: TILLMAN WRIGHT, PLLC, P.O. BOX 473909, CHARLOTTE, NC, 28247, US

(73) Assignee: BOUNCING BRAIN INNOVATIONS SEASON TWO SUBSIDIARY 4 , LLC, Charlotte, NC (US)

(21) Appl. No.: 12/139,246

(22) Filed: Jun. 13, 2008

Related U.S. Application Data
(60) Provisional application No. 60/968,104, filed on Aug. 27, 2007.
(60) Provisional application No. 61/031,357, filed on Feb. 26, 2008.

(51) Int. Cl. G09F 19/00

(52) U.S. Cl. 40/408

(57) ABSTRACT

A method of interacting with a soap bubble fountain, having at least one tubular column extending above a catch basin and provided with a sculpting tool, includes generating soap bubbles with the soap bubble fountain, actuating an air source to force the bubbles from an upper end of the at least one tubular column, repeating the foregoing steps at least until a bubble sculpture is formed between the upper end of the at least one tubular column and the catch basin, and sculpting the bubble sculpture using the sculpting tool.

### CROSS REFERENCE TO RELATED APPLICATIONS

The present application is a U.S. nonprovisional patent application of, and claims priority under 35 U.S.C. §119(e) to, U.S. provisional patent application Ser. No. 60/968,104, filed Aug. 27, 2007, and U.S. provisional patent application Ser. No. 61/031,357, filed Feb. 26, 2008, the entirety of each of which is incorporated herein by reference.

### COPYRIGHT STATEMENT

All of the material in this patent document is subject to copyright protection under the copyright laws of the United States and of other countries. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE PRESENT INVENTION

1. Field of the Present Invention

The present invention generally relates to the use of soap bubbles for entertainment and aesthetic purposes, and, in particular, to recirculating soap bubble fountains that generate bubble sculptures that change or which may be sculpted by a user.

2. Background

Soap bubbles have fascinated people of all ages for centuries. Children have long been entertained by “blowing bubbles” or by the bubbles found in many soap and water mixtures. Scientists of studied the properties of soap bubbles, analyzing how surface tension creates near-perfect spherical objects with many interesting properties. More recently, nightclubs have drawn patrons by blowing soapy foam within or without their establishments.

Over time, different devices have been created to enhance the soap bubble experience through the controlled creation and retention of individual soap bubbles or of soap bubble sculptures. Examples of the latter may be found in U.S. Pat. No. 548,477 to Tacy (“Tacy”) and U.S. Pat. No. 710,814 to Steinhauser (“Steinhauser”), each of which discloses a soap bubble fountain. In Tacy, the fountain utilizes a central upright tube at the upper end of which is disposed a bowl containing a soap solution and at the bottom end of which is arranged a catch-basin. Air is forced upward through the tube to the bottom of the bowl and into the soap solution therein, creating bubbles that fill the bowl and overflow, eventually cascading downward to the catch-basin. Unfortunately, the placement of the soap solution bowl at the top of the tube is quite inconvenient and somewhat unsightly.

In Steinhauser, the bowl containing the soap solution has been removed to the bottom of a vertically-disposed tube. As with Tacy, air is forced into the bottom of this bowl, creating bubbles. The bubbles are forced upward through the tube until they overflow the open top end, again cascading downward to a shallow pan. The resulting bubble sculpture was believed to be useful, at least, as an advertising device.

Although presumably useful to some degree, the Steinhauser device still suffered from at least several shortcomings. First, the bubbles created by the device were forced directly out the top of the vertically-disposed tube. In such an arrangement, the bubbles forced up through the tube tend to stack up on top of the tube, eventually making it difficult for more bubbles to escape the top of the tube because of the weight and arrangement of the bubbles. It is also difficult to control uniform distribution of the bubbles around the tube.

Further inefficiency in the creation of the bubbles results from the injection of air directly into the bottom of the bowl at the bottom of the tube. To escape up the tube, bubbles must first escape the bowl itself, and are frequently and undesirably burst by the frothy or uniform liquid already in the bowl or by drops of liquid falling back into the bowl from the collection pan. These effects make it more difficult to get bubbles up the tube.

Additionally, the vertically-oriented tube set forth in Steinhauser has a narrow opening at the top for emitting bubbles from the tube. As mentioned above, the vertical orientation of the tube forces bubbles to stack up on top of the tube, thereby impeding the even distribution of bubbles from the fountain. This difficulty is compounded by the fact that the tube has a narrow opening at the top of tube, which limits the direction of the bubbles to a single path directly above the tube. As a result, bubbles emitted from the tube are even less likely to be dispersed evenly around the pan.

Still further, Steinhauser fails to disclose any creative interaction with the bubble sculptures creating by the device. The Steinhauser device appears to be intended for use solely as an advertising device that is to be viewed, rather than interacted or “played” with.

In view of the foregoing, it is believed that greater entertainment and aesthetic value could be achieved in a soap bubble fountain than is achieved by prior art devices.

### SUMMARY OF THE PRESENT INVENTION

The present invention includes many aspects and features. Broadly defined, the present invention according to one aspect is a soap bubble fountain, including: a soap holder adapted to contain a soap and water mixture; a tubular column extending upward from the soap holder, wherein an upper end of the tubular column is closed by a top cover, and wherein one or more bubble openings, each penetrating a side wall of the upper end of the tubular column, are arranged around the periphery; a catch basin disposed at a lower portion of the tubular column; and an air source arranged to inject air into the soap and water mixture, thereby creating soap bubbles; wherein the soap bubbles are forced through the bubble openings in the upper end of the tubular column and are subsequently collected in the catch basin.

In a feature of this aspect, the air source is an air pump. In further features, the air pump is battery-operated; and the air pump is operated by an electrical motor.

In another feature of this aspect, the soap bubble fountain further includes one or more light sources to provide a lighting effect in the collected bubbles. In further features, each light source includes a light emitting diode (LED); the LEDs are configured to emanate from a base portion of the bubble fountain; and the LEDs are arranged generally beneath the tubular column.

In another feature of this aspect, the bubble fountain is configured to have the shape of a bottle.

In another feature of this aspect, the bubble fountain is configured to have the shape of a dragon.

Broadly defined, the present invention according to another aspect is a soap bubble fountain, including: a soap holder adapted to contain a first portion of a soap and water mixture; a tubular column extending upward from the soap holder, wherein a lower end of the tubular column is adapted to contain a second portion of the soap and water mixture, and wherein the lower end of the tubular column is in fluid communication with, but partitioned from, a bottom of the soap holder; a catch basin disposed at a lower portion of the tubular column; and an air source arranged to inject air into the second portion of the soap and water mixture, contained in the lower end of the tubular column, thereby creating soap bubbles; wherein the soap bubbles are forced out of an upper end of the tubular column and are subsequently collected in the catch basin.

In a feature of this aspect, the air source is an air pump. In further features, the air pump is battery-operated; and the air pump is operated by an electrical motor.

In another feature of this aspect, the soap bubble fountain further includes one or more light sources to provide a lighting effect in the collected bubbles. In further features, each light source includes a light emitting diode (LED); the LEDs are configured to emanate from a base portion of the bubble fountain; and the LEDs are arranged generally beneath the tubular column.

In another feature of this aspect, the bubble fountain is configured to have the shape of a bottle.

In another feature of this aspect, the bubble fountain is configured to have the shape of a dragon.

Broadly defined, the present invention according to another aspect is a soap bubble fountain, including: a soap holder adapted to contain a soap and water mixture; a tubular column having a non-uniform width along the length thereof extending upward from the soap holder, wherein an upper end of the tubular column is open to provide a bubble opening; a catch basin disposed at a lower portion of the tubular column; and an air source arranged to inject air into the soap and water mixture, thereby creating soap bubbles; wherein the soap bubbles are forced through the bubble opening in the upper end of the tubular column and are subsequently collected in the catch basin.

In a feature of this aspect, the bubble fountain further includes one or more light sources to provide a lighting effect in the collected bubbles.

In another feature of this aspect, the tubular column is flared at the upper end thereof.

In another feature of this aspect, the tubular column has a bulbous portion at the upper end thereof.

Broadly defined, the present invention according to another aspect is a soap bubble fountain, including: a soap holder adapted to contain a soap and water mixture; a plurality of tubular columns extending upward from the soap holder, wherein an upper end of each of the tubular columns is open to provide a bubble opening corresponding to each tubular column; a catch basin disposed at a lower portion of the tubular columns; and an air source arranged to inject air into the soap and water mixture, thereby creating soap bubbles; wherein the soap bubbles are distributed among and forced through the bubble openings corresponding to the plurality of tubular columns and are subsequently collected in the catch basin.

In a feature of this aspect, the air source is an air pump. In further features, the air pump is battery-operated; the air pump is operated by an electrical motor; and the air pump is a double-diaphragm pump.

In another feature of this aspect, the soap bubble fountain further includes one or more light sources to provide a lighting effect in the collected bubbles. In further features, each light source includes a light emitting diode (LED); the LEDs are configured to emanate from a base portion of the bubble fountain; and the LEDs are arranged generally beneath the plurality of tubular columns.

In another feature of this aspect, at least one of the tubular columns is flared at the upper end thereof.

In another feature of this aspect, at least one of the tubular columns has a non-vertical orientation. In a further feature, each of the plurality of tubular columns has a different tilt angle.

In another feature of this aspect, at least one of the tubular columns has a non-uniform width.

In another feature of this aspect, at least one of the tubular columns has a bulbous portion at the upper end thereof.

In another feature of this aspect, the bubble fountain is configured to have the shape of a bottle.

In another feature of this aspect, the bubble fountain is configured to have the shape of a dragon.

Broadly defined, the present invention according to another aspect is a soap bubble fountain, including: a soap holder adapted to contain a soap and water mixture; at least one tubular column extending upward from the soap holder, wherein at least one bubble opening is arranged at an upper end of the at least one tubular column; a catch basin disposed at a lower portion of the at least one tubular column; a plurality of tubes, each emptying directly into an interior of at least one tubular column at the bottom thereof, and an air source arranged to inject air into the soap and water mixture by distributing the air through the plurality of tubes and into the interior of the at least one tubular column, thereby creating soap bubbles; wherein the soap bubbles are forced through the at least one bubble opening and are subsequently collected in the catch basin.

In a feature of this aspect, the at least one tubular column is a plurality of tubular columns, and each tube empties directly into an interior of a respective tubular column. In further features, the air source is an air pump; the air pump is a double-diaphragm pump; the double-diaphragm pump has two pump assemblies, and each side is connected to a respective one of the plurality of tubes; each side of the pump assemblies is connected to its respective tube via an inlet having an inlet port and two outlet ports; each tube is an inverted J-tube; and the plurality of tubular columns includes four tubular columns, and each pump assembly is fluidly connected to two of the four tubular columns.

In another feature of this aspect, each tube is an inverted J-tube.

Broadly defined, the present invention according to another aspect is a method of interacting with a soap bubble fountain, having at least one tubular column extending above a catch basin and provided with a sculpting tool, including the steps of: generating soap bubbles with the soap bubble fountain; actuating an air source to force the bubbles from an upper end of the at least one tubular column; repeating the previous two steps at least until a bubble sculpture is formed between the upper end of the at least one tubular column and the catch basin; and sculpting the bubble sculpture using the sculpting tool.

In a feature of this aspect, the air source is an air pump. In further features, the air pump is battery-operated; the air pump is operated by an electrical motor; and the air pump is a double-diaphragm pump.

In another feature of this aspect, the method further includes actuating one or more light sources to provide a lighting effect in the collected bubbles. In further features, each light source includes a light emitting diode (LED); the LEDs are configured to emanate from a base portion of the bubble fountain; and the LEDs are arranged generally beneath the tubular column.

In another feature of this aspect, the at least one tubular column is flared at the upper end thereof.

In another feature of this aspect, the at least one tubular column has a non-vertical orientation.

In another feature of this aspect, the at least one tubular column has a non-uniform width.

In another feature of this aspect, the at least one tubular column has a bulbous portion at the upper end thereof.

In another feature of this aspect, the bubble fountain is configured to have the shape of a bottle.

In another feature of this aspect, the bubble fountain is configured to have the shape of a dragon.

Broadly defined, the present invention according to another aspect is a method of interacting with a soap bubble fountain, having a plurality of tubular columns extending above a catch basin in a non-vertical orientation and provided with a sculpting tool, including the steps of: generating soap bubbles with the soap bubble fountain; actuating an air source to force the bubbles from an upper end of the at least one tubular column; repeating the previous two steps at least until a bubble sculpture is formed between the upper end of the at least one tubular column and the catch basin; sculpting the bubble sculpture using the sculpting tool; and actuating one or more light sources to provide a lighting effect in the bubble sculpture.

In a feature of this aspect, at least one of the tubular columns is flared at the upper end thereof.

In another feature of this aspect, at least one of the tubular columns has a bulbous portion at the upper end thereof.

In another feature of this aspect, each of the plurality of tubular columns has a different tilt angle.

In another feature of this aspect, soap bubbles are distributed among the plurality of tubular columns.

In addition to the aforementioned aspects and features of the present invention, it should be noted that the present invention further encompasses the various possible combinations of such aspects and features, as well as aspects and features otherwise disclosed herein.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a front perspective view of a bubble fountain in accordance with a preferred embodiment of the present invention;

FIG. 2 is an exploded front perspective view of the bubble fountain of FIG. 1;

FIG. 3 is an enlarged front perspective view of an upper portion of the bubble fountain of FIG. 1;

FIGS. 4A-4D are front perspective views of the bubble fountain of FIG. 1, shown in various stages of operation;

FIG. 5 is an enlarged front cross-sectional view of a lower portion of the bubble fountain of FIG. 1;

FIG. 6 is a front perspective view of a bubble fountain in accordance with another preferred embodiment of the present invention;

FIG. 7 is a front perspective view of a bubble fountain in accordance with another preferred embodiment of the present invention;

FIG. 8 is a front perspective view of a bubble fountain in accordance with another preferred embodiment of the present invention;

FIG. 9 is a front perspective view of a bubble fountain in accordance with another preferred embodiment of the present invention;

FIGS. 10A and 10B are front perspective views of a bubble fountain in accordance with another preferred embodiment of the present invention;

FIG. 11 is a front elevational view of the bubble fountain of FIGS. 10A and 10B;

FIG. 12 is a left side elevational view of the bubble fountain of FIGS. 10A and 10B;

FIG. 13 is a right side elevational view of the bubble fountain of FIGS. 10A and 10B;

FIG. 14 is a rear elevational view of the bubble fountain of FIGS. 10A and 10B;

FIG. 15 is a top plan view of the bubble fountain of FIGS. 10A and 10B;

FIG. 16A is a bottom plan view of the bubble fountain of FIGS. 10A and 10B;

FIG. 16B is a sectional bottom plan view of the bubble fountain of FIGS. 10A and 10B, shown with the base cover removed;

FIGS. 17A and 17B are partial cross-sectional front views of the bubble fountain of FIG. 13, taken along line 17-17;

FIGS. 18A and 18B are partial cross-sectional side views of the bubble fountain of FIG. 12, taken along line 18-18;

FIGS. 19A and 19B are partial cross-sectional side views of the bubble fountain of FIG. 12, taken along line 19-19;

FIGS. 20A and 20B are cross-sectional top view of the bubble fountain of FIG. 13, taken along line 20-20;

FIGS. 21A and 21B are cross-sectional top views of the bubble fountain of FIG. 13, taken along line 21-21;

FIGS. 22A and 22B are bottom orthogonal views of the catch basin and base of the bubble fountain of FIGS. 10A and 10B;

FIGS. 23 and 24 are front perspective views of a bubble fountain in accordance with another preferred embodiment of the present invention;

FIG. 25 is a front perspective view of bubble fountain in accordance with another preferred embodiment of the present invention; and

FIGS. 26-27 are front perspective views of a bubble fountain in accordance with another preferred embodiment of the present invention.

### DETAILED DESCRIPTION OF THE PREFERRED EMBODIMENTS

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein-as understood by the Ordinary Artisan based on the contextual use of such term-differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, the preferred embodiments of the present invention are next described. The following description of the preferred embodiment(s) is merely exemplary in nature and is in no way intended to limit the invention, its application, or uses.

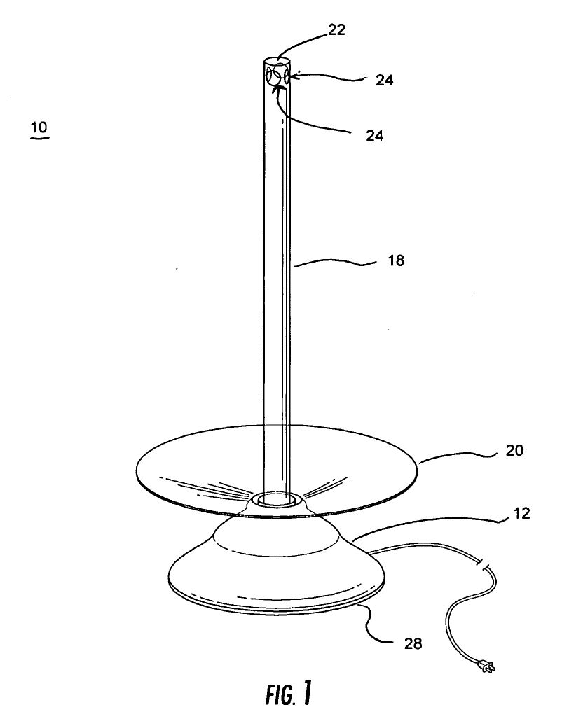

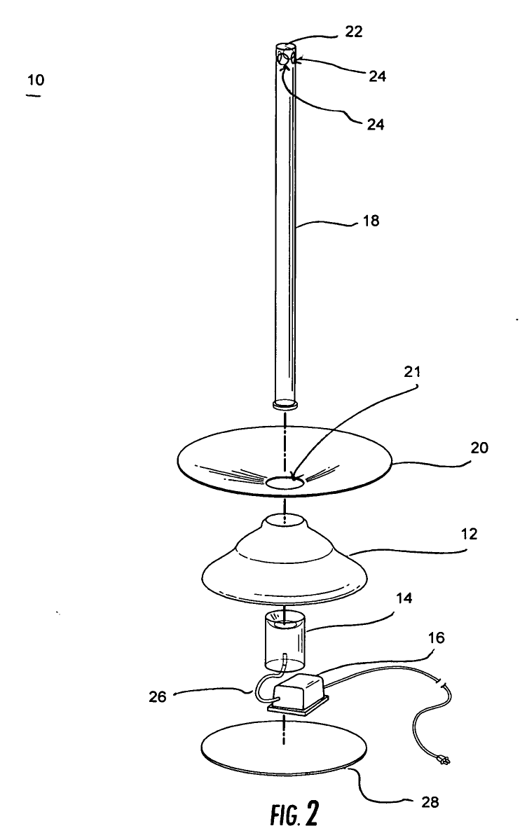

FIGS. 1 and 2 are a front perspective view and an exploded front perspective view, respectively, of a bubble fountain 10 in accordance with a preferred embodiment of the present invention. As shown therein, the bubble fountain 10 includes a base 12, a soap holder 14, a pump 16, a tubular column 18 and a catch basin 20. The tubular column 18 is seated in the bottom of the soap holder 14, which is in turn disposed within, or optionally forms a part of, the base 12, and extends upward through a center opening 21 in the catch basin 20.

The pump 16 is preferably also disposed within the base 12 and has a fluid outlet that is connected to the interior of the soap holder 14 via a flexible tube 26 or the like, thereby permitting air to be pumped into the soap holder 14. The pump 16 and soap holder 14 may be supported within the base 12 by a base cover 28 that is preferably removable in order to provide access to the pump 16 or other components disposed therein. In at least some embodiments, the pump 16 uses an electrical motor that may be plugged into a standard wall outlet, but other embodiments may utilize battery- or hand-operated pumps.

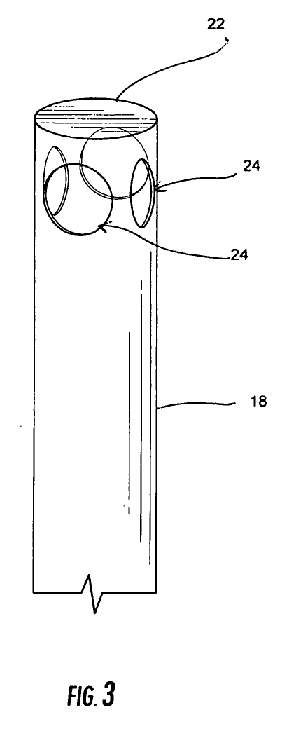

FIG. 3 is an enlarged front perspective view of an upper portion of the bubble fountain 10 of FIG. 1. As shown therein, the upper end of the tubular column 18 is closed by a top cover 22 and includes a plurality of bubble openings 24 arranged around its periphery. The openings 24, which may be of any desired size, shape and arrangement, each penetrate the side walls of upper end of the column 18 and are provided to allow bubbles to escape therethrough as described hereinbelow.

In use, the soap holder 14 is partially filled with a soap and water mixture that is formulated to produce soap bubbles when air is pumped into the holder 14. A number of conventional formulations, typically including some mixture of water and glycerin, are available for this purpose.

With the soap and water mixture in place, the pump 16 is activated, thereby causing the mixture to be infused with air, creating soap bubbles. With space limited between the top of the soap holder 14 and the walls of the tubular column 18, the soap bubbles are forced up into the column 18.

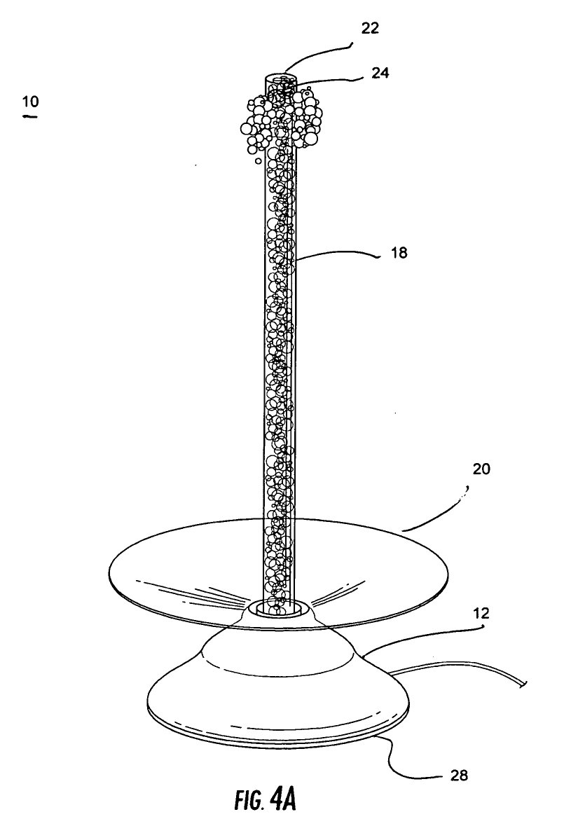

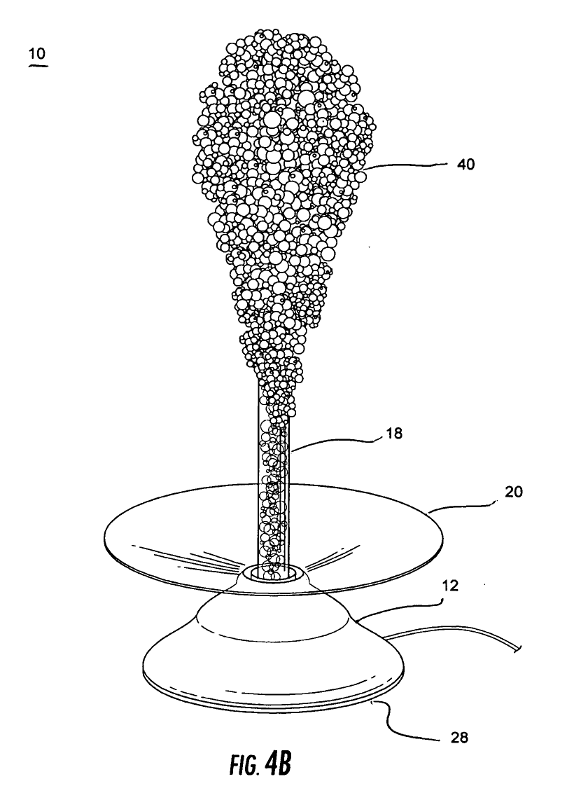

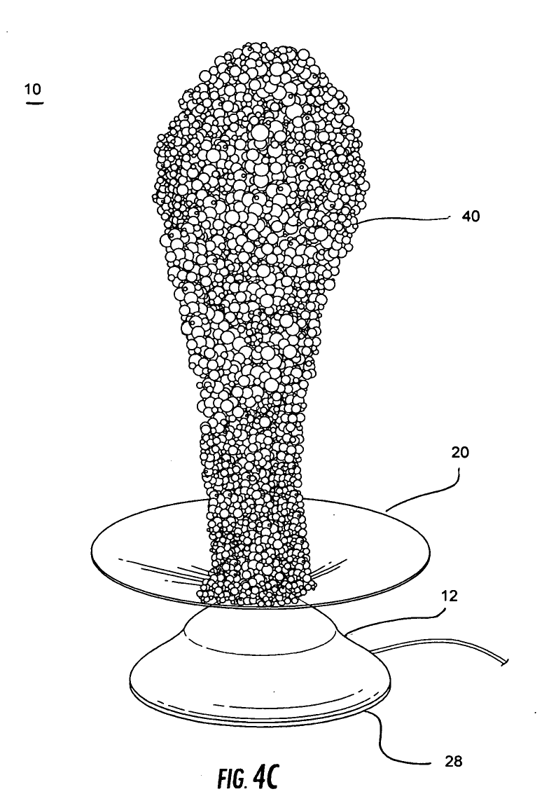

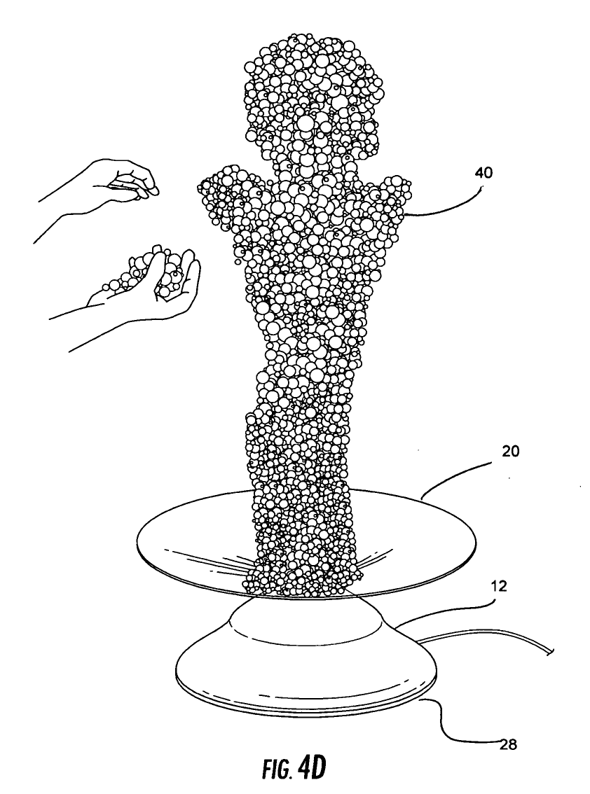

FIGS. 4A-4D are front perspective views of the bubble fountain 10 of FIG. 1, shown in various stages of operation. As more and more bubbles are created, they finally reach the top of the column 18. The top cover 22 forces the bubbles to begin escaping the column 18 via the bubble openings 24 around the periphery thereof, as shown in FIG. 4A. Because bubbles escape through the sides of the column 18, rather than an open end at the top, the bubbles are less likely to stack up on themselves wherein their own weight could cause them to pop or to compress into a soapy foam rather than a more aesthetically-pleasing collection of larger bubbles. Further, the closed end (top cover 22) improves the distribution of bubbles around the top of the column 18 by forcing bubbles out on all sides of the column 18. Alternatively, the bubbles could be forced to one side or another through the use of a more limited set of openings 24, i.e., through the use of openings limited in distribution to a portion of the periphery of the column 18, rather than distributed around the entire periphery. Such a bubble distribution would be more difficult to achieve with an open ended-column.

As still more bubbles are created and are forced through the openings 24, the bubbles begin to take on the form of a bubble sculpture 40, as shown in FIGS. 4B and 4C. More particularly, the bubbles slowly inch down the outside of the column 18, as shown in FIG. 4B, until they reach the catch basin 20, as shown in FIG. 4C. Continued formation of the bubble sculpture 40 thereafter may depend on the consistency of the selected soap and water mixture as well as on environmental conditions during operation of the fountain 10. Some number of bubbles in the sculpture 40, particularly at the bottom thereof, will pop under the weight of the bubbles above and as environmental factors affect the surface tension thereof, and the liquid released thereby will be collected in the catch basin 20 and will flow toward the center, where it passes through to the soap holder 14 beneath. The remaining bubble sculpture 40, however, may bulge at the bottom, the middle, or the top, creating an ongoing and ever-changing variety of visually pleasing shapes and forms. These shapes may be further varied manually, by blowing, touching or otherwise manipulating portions of the sculpture 40, such as is shown in FIG. 4D. Although not shown, various tools, such as wands and scrapers having various contours, may be provided for this purpose.

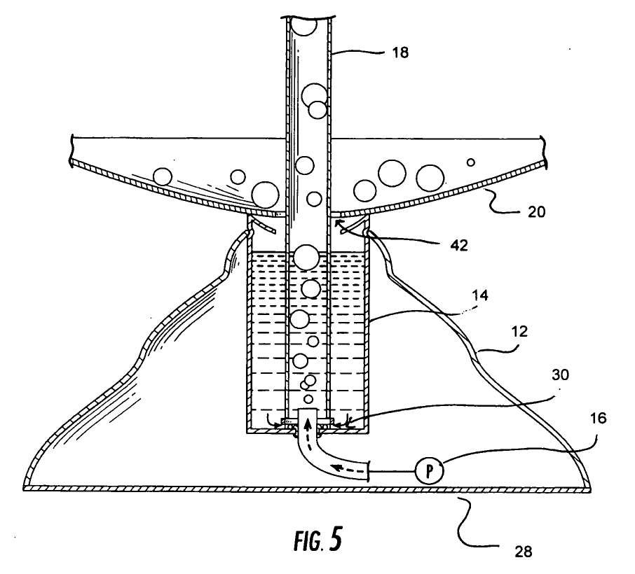

FIG. 5 is an enlarged front cross-sectional view of a lower portion of the bubble fountain 10 of FIG. 1, illustrating the circulation of the soap and water mixture through the fountain 10. As shown therein, bubbles from the bubble sculpture 40 pop and the liquid created thereby collects in the catch basin 20. The liquid flows to the center of the catch basin 20 and drains through one or more openings 42 into the soap holder 14 below. The openings 42 may comprise spaces between the edges of the center opening 21 in the catch basin 20 and the outer surfaces of the column 18, or they may be dedicated perforations or other openings (not shown) that are spaced apart a small distance from the center opening 21 and the column 18 extending therethrough. In the soap holder 14, the collected bubble liquid mixes with the soap and water already there. The combined mixture enters the bottom of the tubular column 18, where air from the pump 16 once again causes the creation of bubbles as described previously. The flow of liquid into the column 18 may be accomplished via openings (not shown) in the column 18, or through a gap 30 at the bottom of the column 18 as shown in FIG. 5.

A useful aspect of the illustrated bubble creation process is its improved efficiency in producing bubbles. More particularly, creating bubbles directly in the tubular column 18 through the injection of air into the soap and water mixture therein is believed to be more efficient than creating the bubbles first in the soap holder 14 and then forcing them into the column 18. One reason for this is that the bubbles created in the tubular column 18 are protected by the walls of the column 18 from being burst prematurely by liquid dripping back into the soap holder 14, and thus relatively larger bubbles, rather than a mix of smaller bubbles perhaps better characterized as foam or froth, may be created. Further, a good supply of liquid, rather than the aforementioned foam or forth, may be generated in the soap holder 14 and maintained in the bottom of the soap holder 14 and column 18 by the natural flow of liquid from burst soap bubbles into the soap holder 14 and the natural settling effect of that liquid.

Further interest may be created by providing one or more light sources (not shown) to provide various lighting effects in the bubble sculpture 40. Such light sources may be arranged to appear to emanate from within the bubble sculpture 40 or may be arranged behind the bubble sculpture 40 as the sculpture is seen by a viewer. Any conventional light source of any color may be used, though in at least some embodiments it may be necessary to protect the light source from the soap bubbles themselves.

The bubble fountain 10 may be configured to have any of a variety of different shapes and sizes. In one contemplated embodiment, the bubble fountain 10 may be configured to have the general shape of a champagne or wine bottle, whereby bubbles may be emitted, for example, from the mouth of the bottle. In another contemplated embodiment, the bubble fountain 10 may be configured to have the general shape of a creature such as a dragon, whereby bubbles may be emitted from the mouth or nostrils of the dragon. It can therefore be appreciated by the Ordinary Artisan that the bubble fountain 10 of the present invention may be implemented across a wide variety of different shapes and sizes without departing from the scope of the present invention.

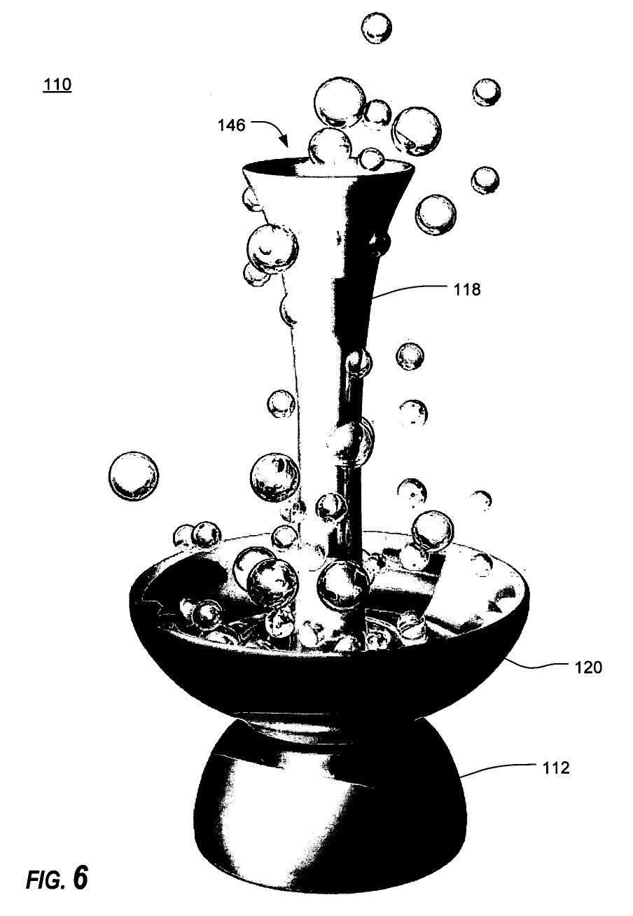

FIG. 6 is a front perspective view of a bubble fountain 110 in accordance with another preferred embodiment of the present invention. As shown therein, the bubble fountain 110 has a tubular column 118 that is flared at the upper end thereof. Additionally, the upper end of the tubular column 118 is open to provide a bubble opening 146 at the top of the bubble fountain 110. Bubbles created by the bubble fountain 110 eventually reach the top of the tubular column 118 and escape via the bubble opening 146. The flared shape of the bubble opening 146 provides a broad range of direction to the bubbles as they are emitted from the tubular column 118, thereby permitting the bubbles to be distributed more evenly to the periphery of the bubble fountain 110. In this regard, the flared shape of the bubble opening 146 helps circumvent the concerns associated with known bubble fountains with a narrow opening. In particular, the flared shape of the bubble opening 146 helps to avoid the problem of bubbles stacking on top of a narrow opening in the tubular column.

As further shown in FIG. 6, a base 112 of the bubble fountain 110 may be configured to have a catch basin 120 to collect bubbles emitted from the tubular column 118. The catch basin 120 may be formed integrally with the base 112, as shown in FIG. 6, or the catch basin 120 and the base 112 may be formed as separate components.

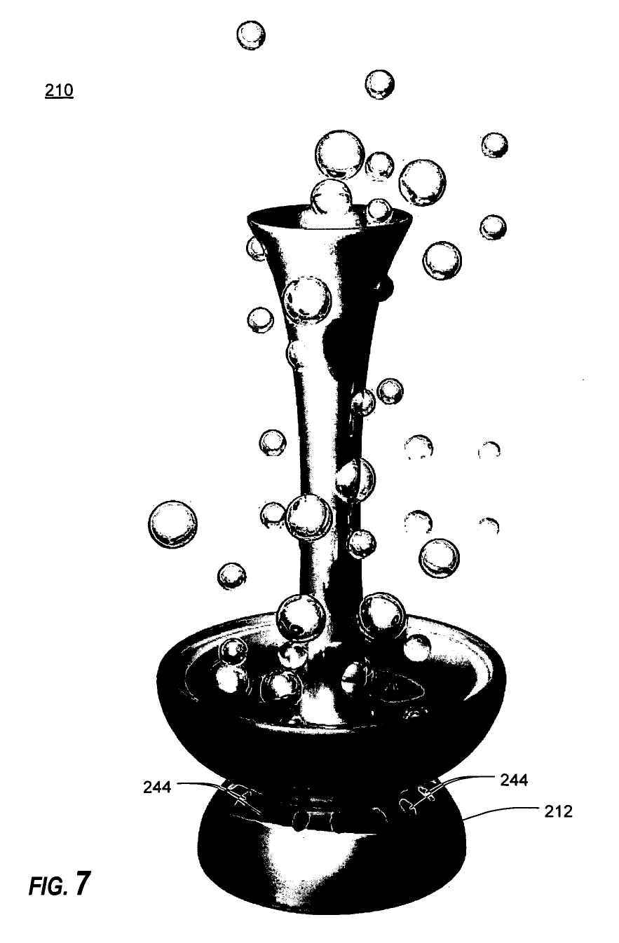

FIG. 7 is a front perspective view of a bubble fountain 210 in accordance with another preferred embodiment of the present invention. As shown therein, the bubble fountain 210 may be configured to have one or more lights 244 to provide the bubble fountain 210 with various lighting effects in a bubble sculpture created by the bubble fountain 210. The lights 244 may be configured in any manner that might be preferred and may be powered by batteries or an electrical source (not shown). As shown in FIG. 7, the lights 244 are configured to emanate from the base 212 of the bubble fountain 210. Additionally, the lights 244 may be arranged in any manner that might be preferred. As shown in FIG. 7, the lights 244 are arranged to be relatively evenly spaced along the upper portion of the base 212 to direct lighting effects upward toward a bubble sculpture. Any type of light source may be utilized in connection with the lights 244. In at least one embodiment, the light source corresponding to each light 244 is a light emitting diode (LED).

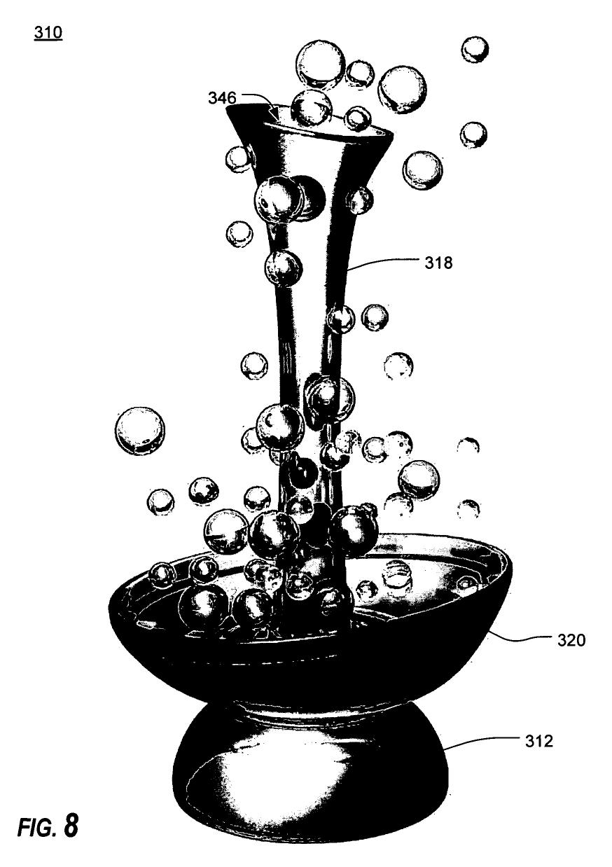

FIG. 8 is a front perspective view of a bubble fountain 310 in accordance with another preferred embodiment of the present invention. As shown therein, the bubble fountain 310 may be configured to have an offset appearance. In particular, a catch basin 320 may be slightly tilted so as to appear offset with respect to a base 312 and a tubular column 318. The tilted configuration of the catch basin 320 may also provide a different appearance in a bubble sculpture created by the bubble fountain 310. As further shown in FIG. 8, the bubble opening 346 of the tubular column 318 may be angled rather than straight. In this regard, bubbles escaping via the bubble opening 346 may have a natural tendency to collect at one side of the catch basin 320. The angle of the bubble opening 346 may be varied across a range of possible angles in order to adjust the likelihood of bubbles collecting at one side of the catch basin 320. The angled bubble opening 346 thereby facilitates the creation of a bubble sculpture having a different appearance. The tilted catch basin 320 may be oriented with its higher side generally beneath the angled lower edge of the bubble opening 346, thereby more effectively collecting the larger amount of bubbles that may accumulate on that side.

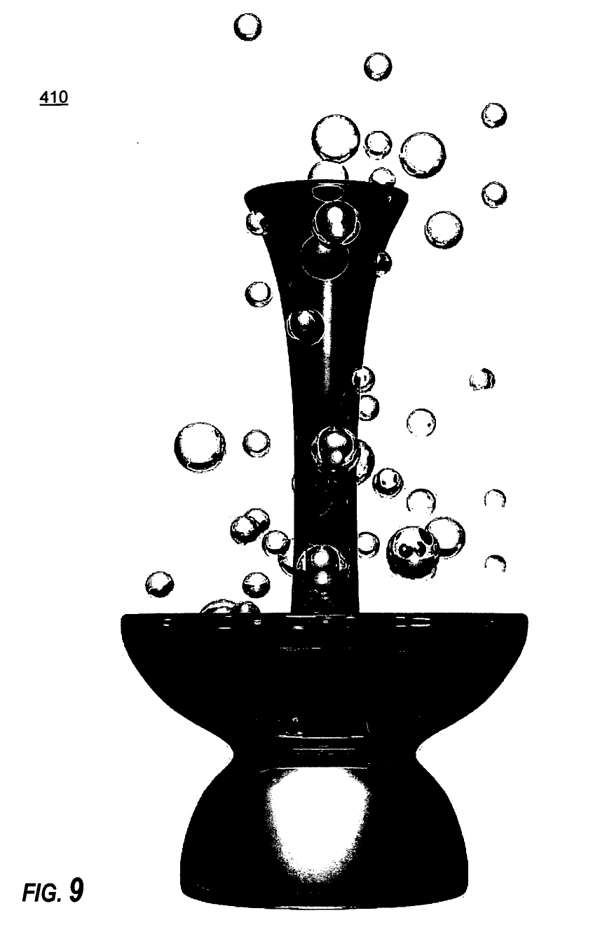

FIG. 9 is a front perspective view of a bubble fountain 410 in accordance with another preferred embodiment of the present invention. As shown therein, the bubble fountain 410 may be composed of a generally transparent material.

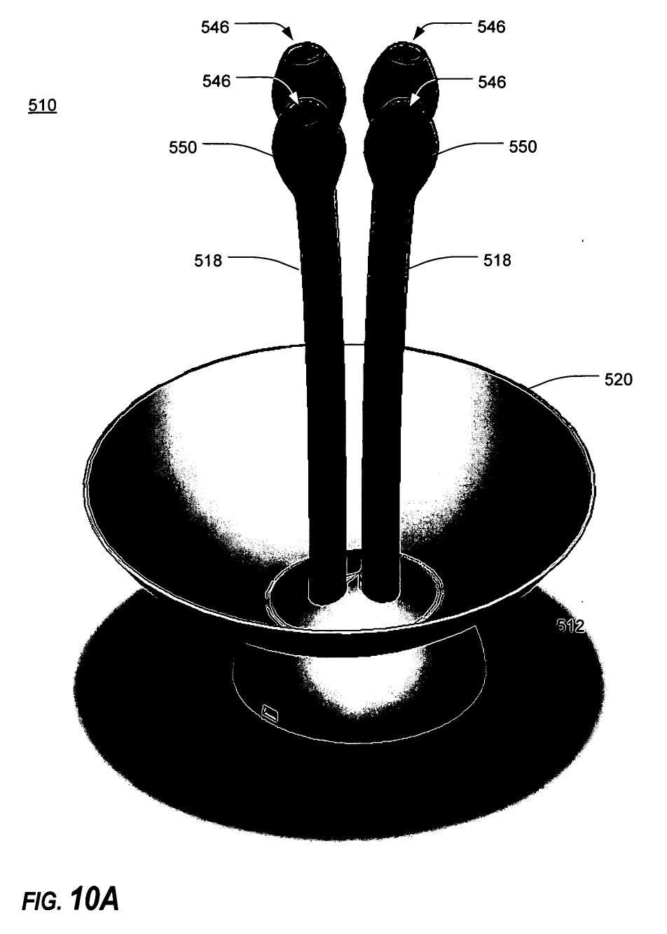

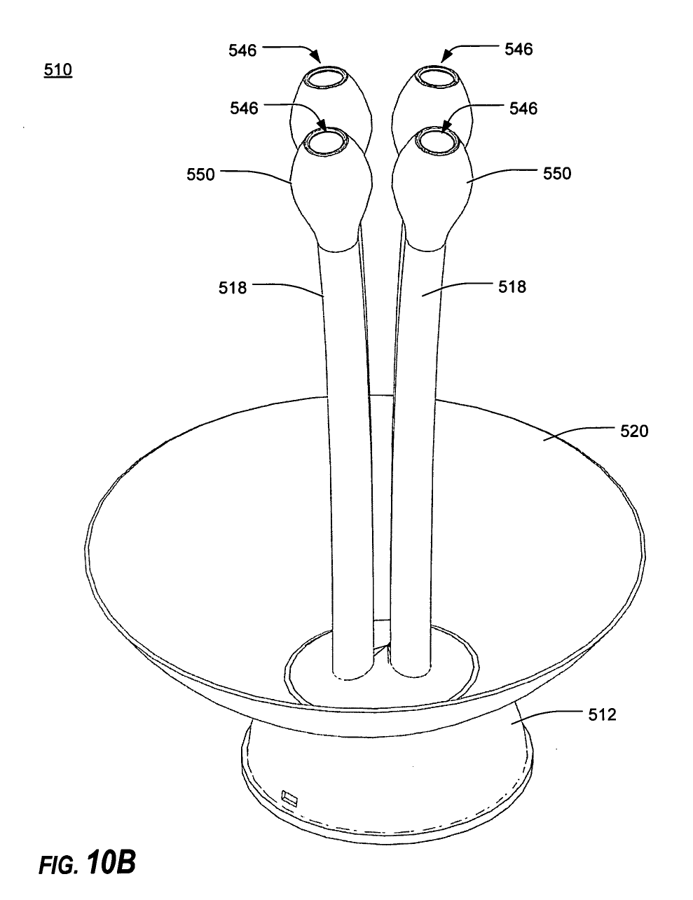

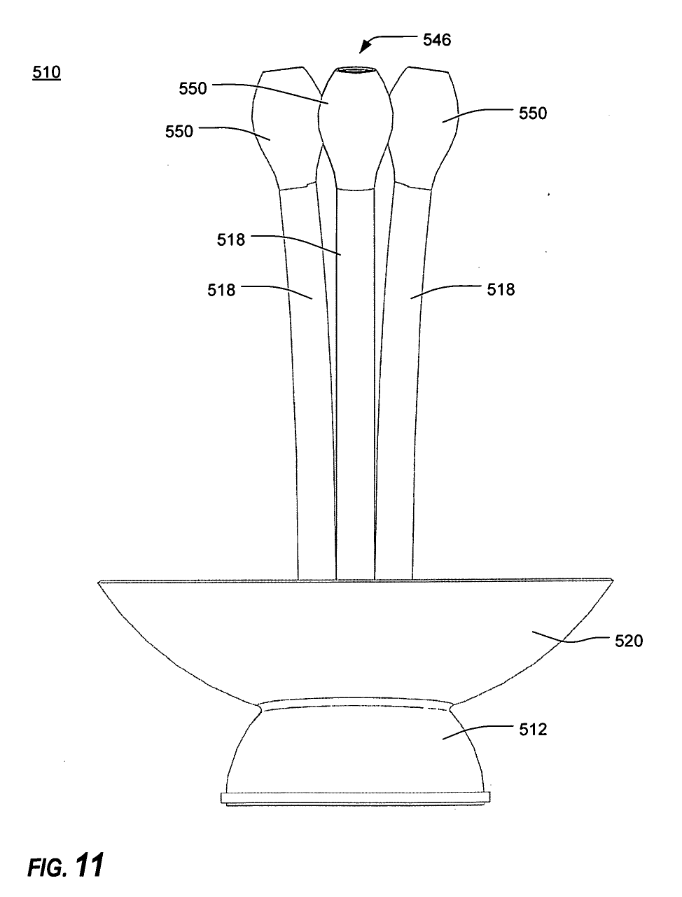

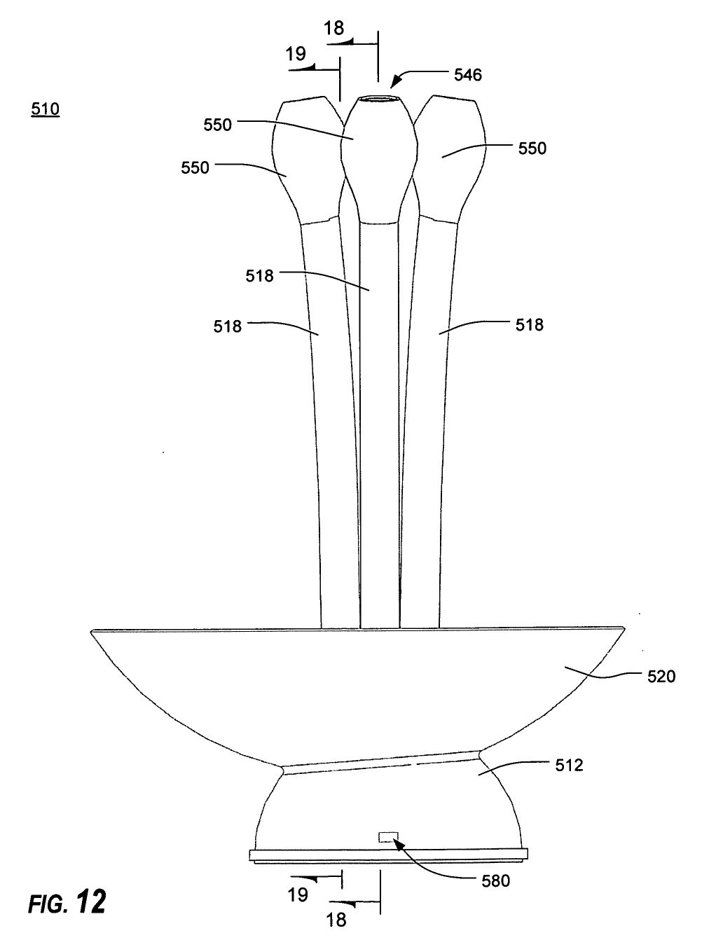

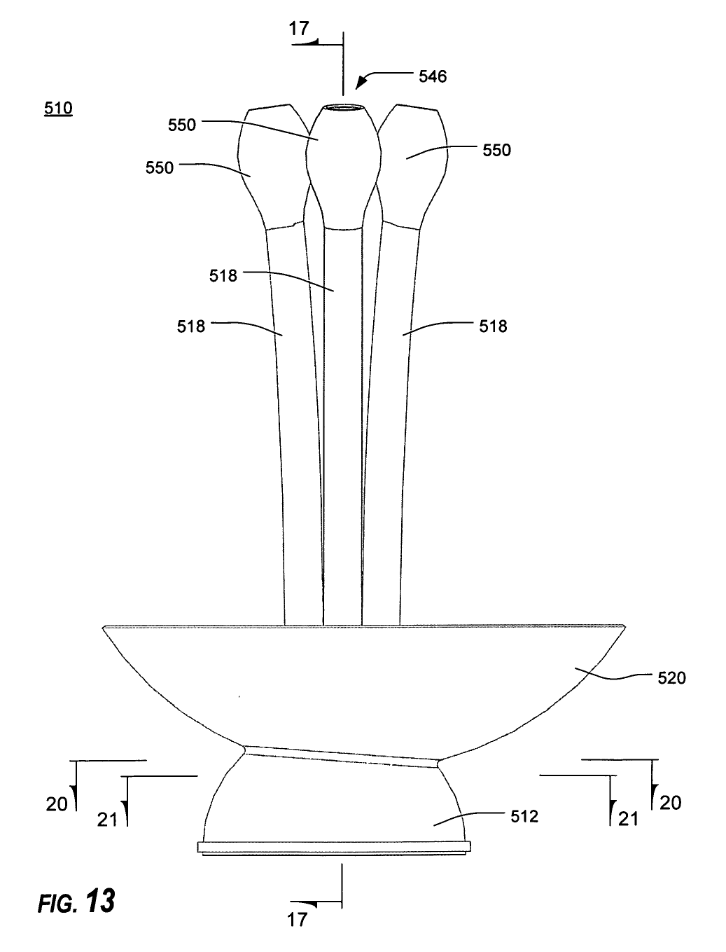

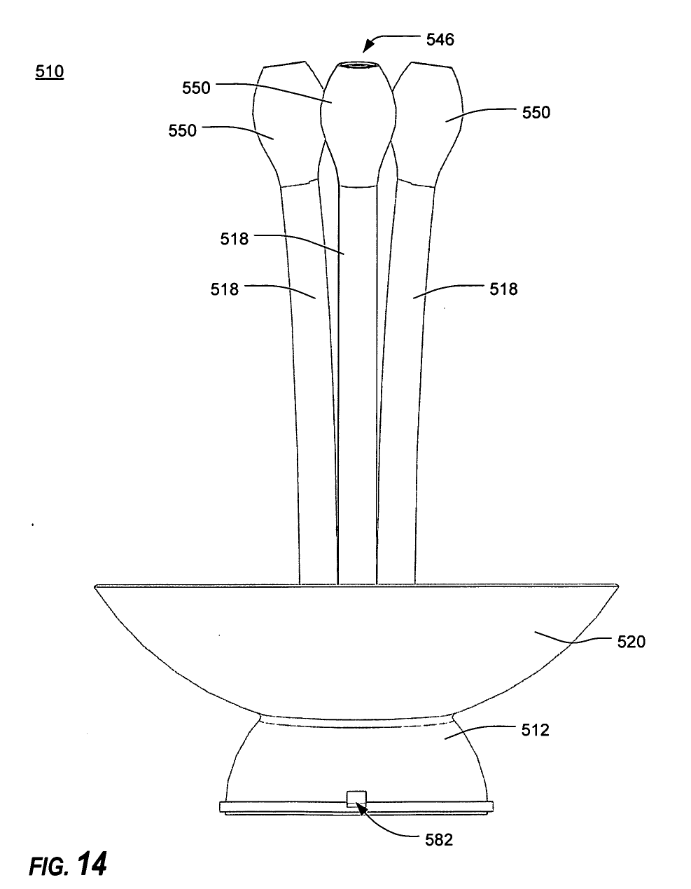

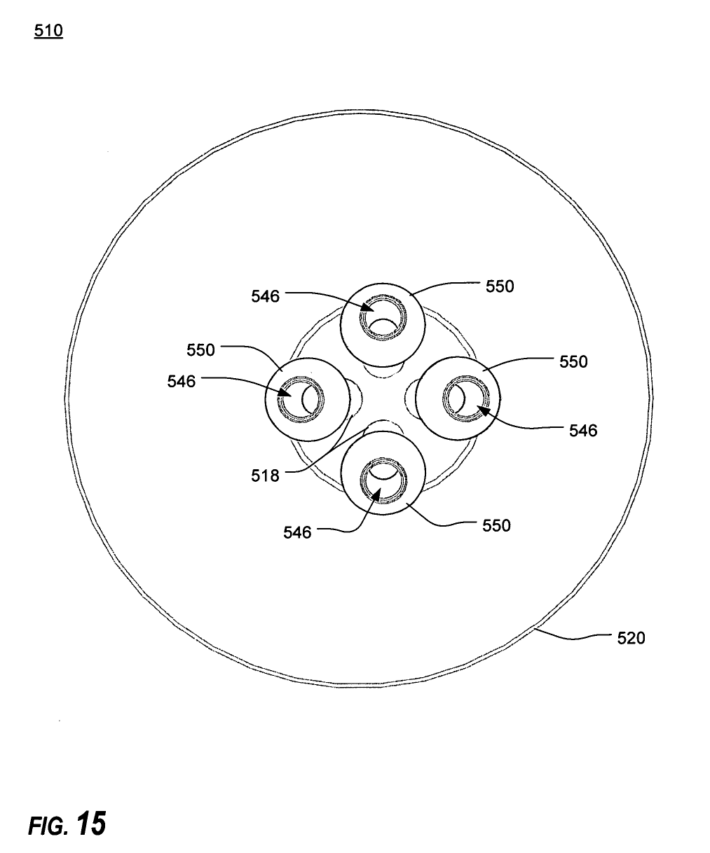

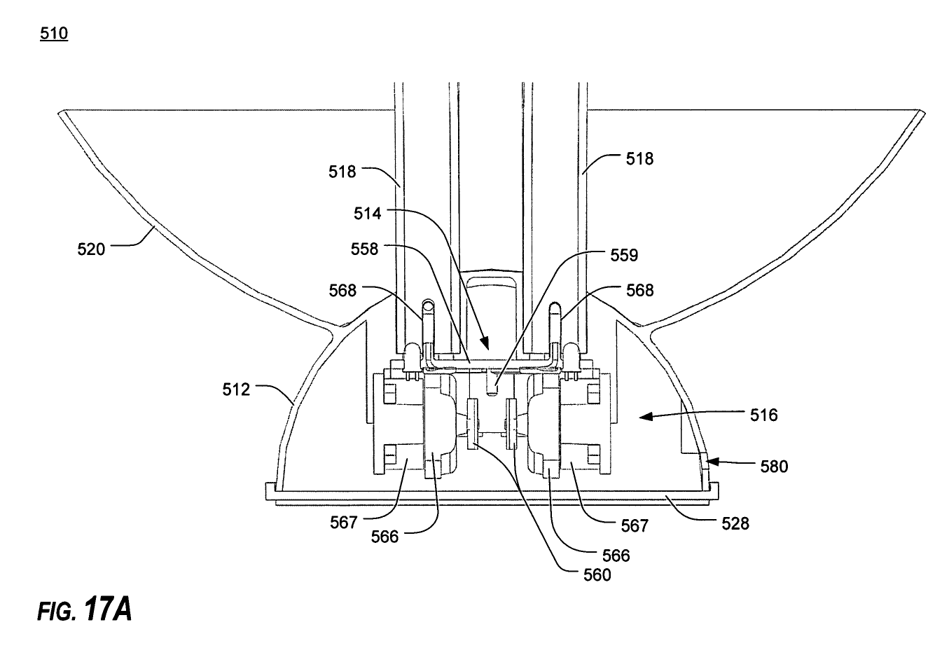

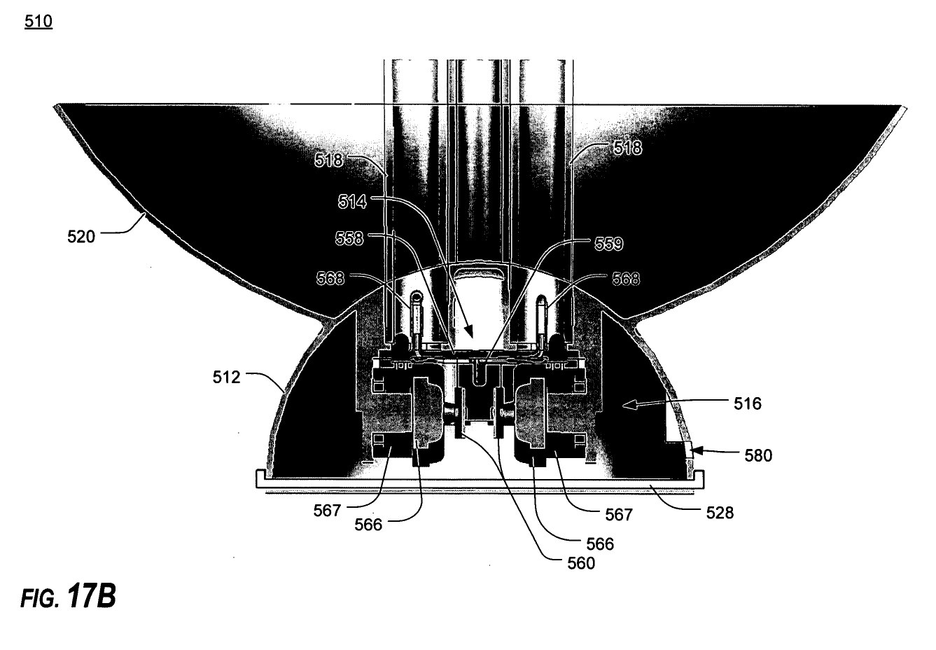

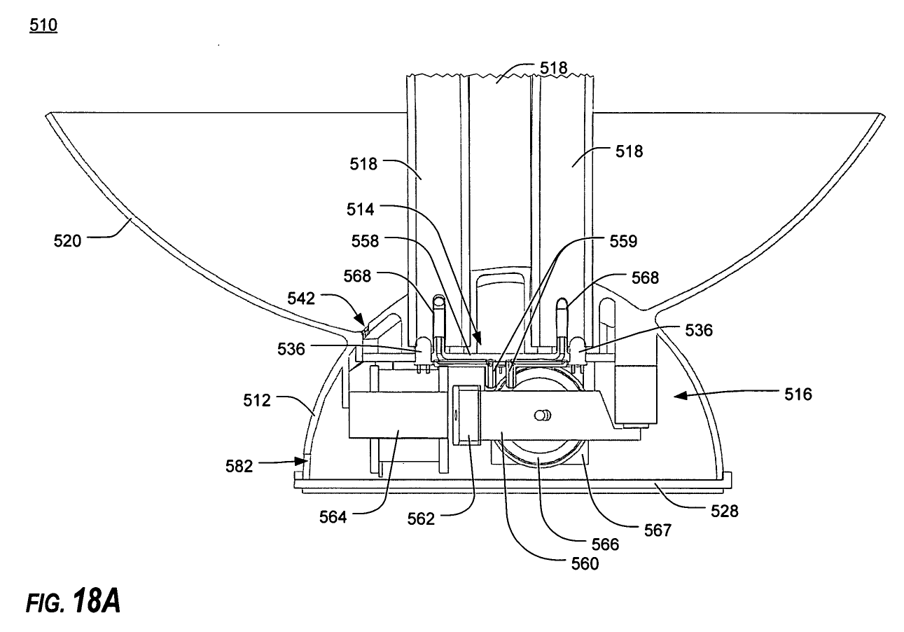

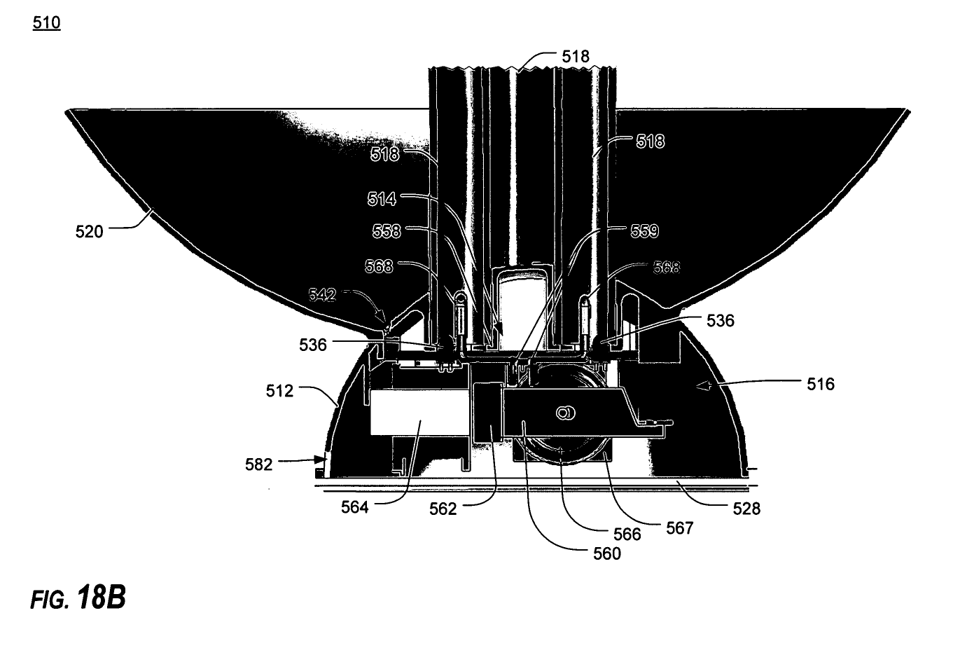

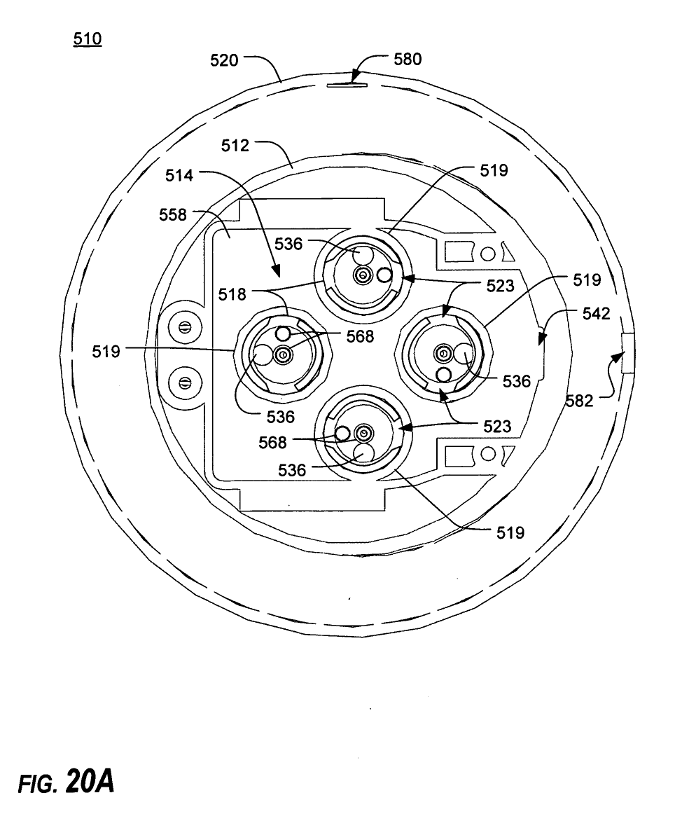

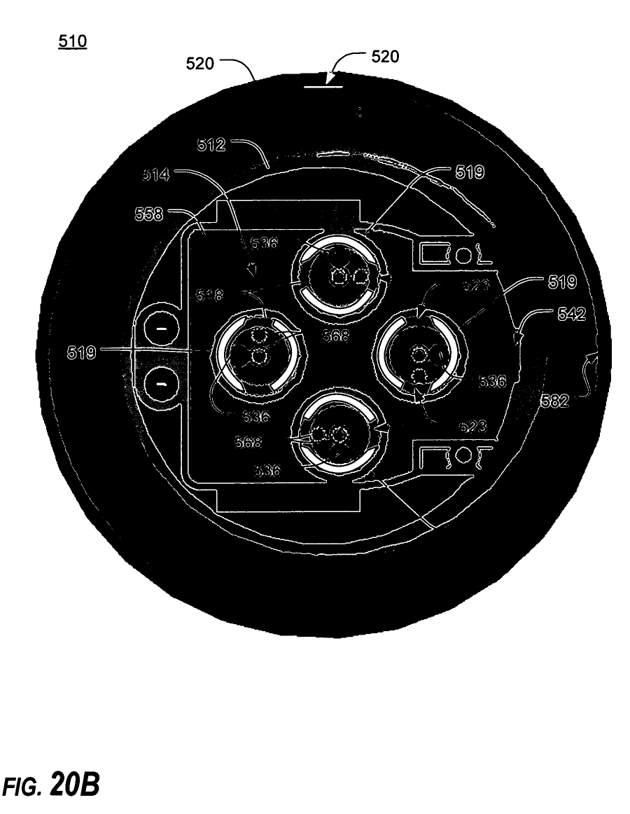

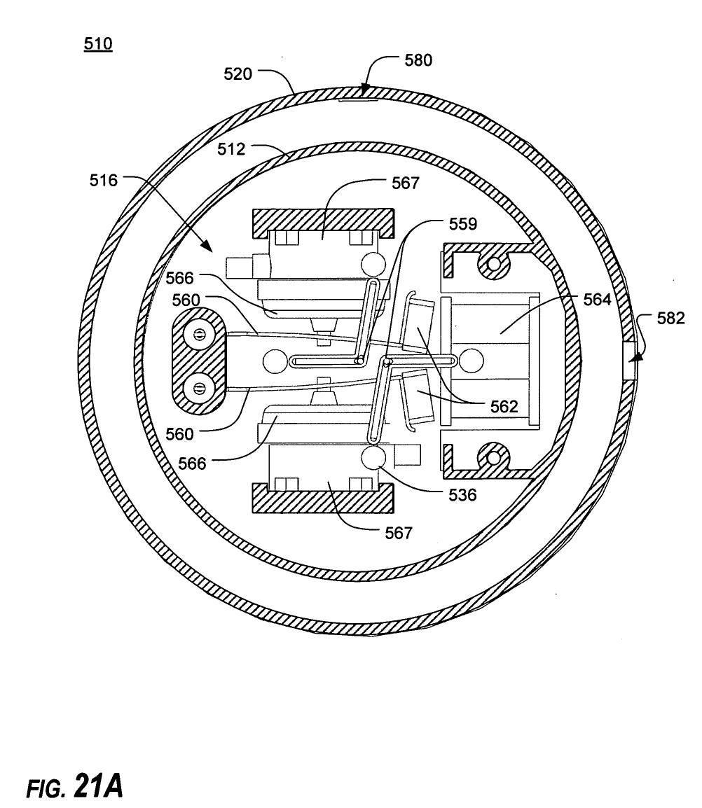

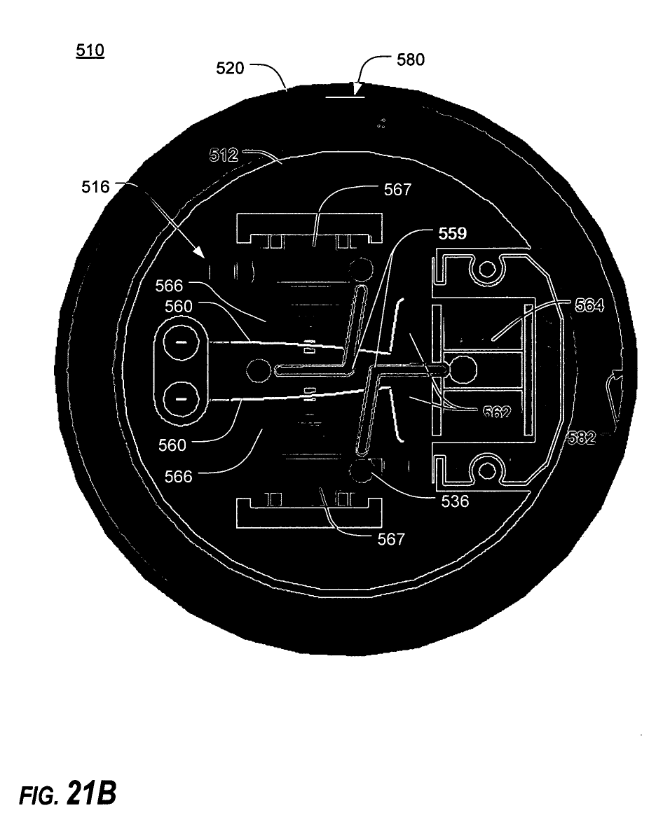

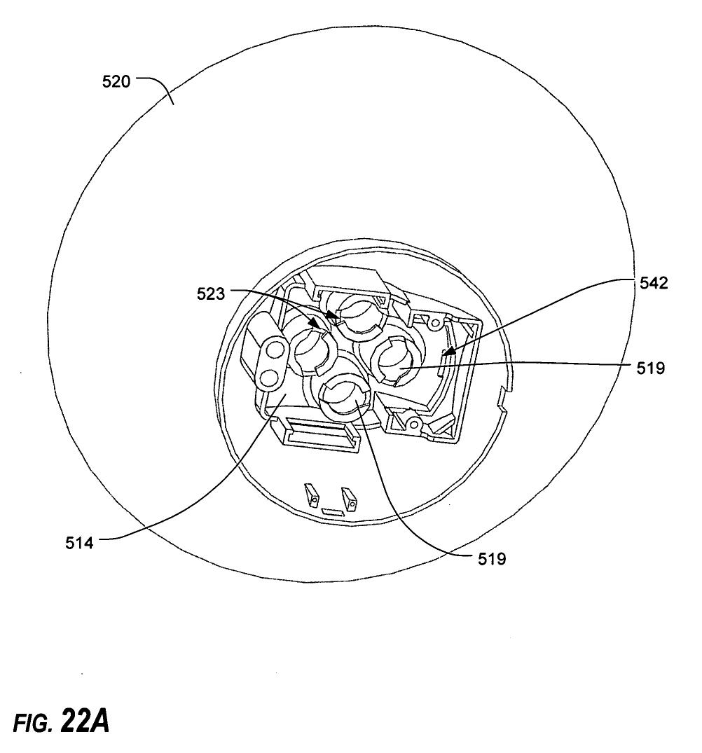

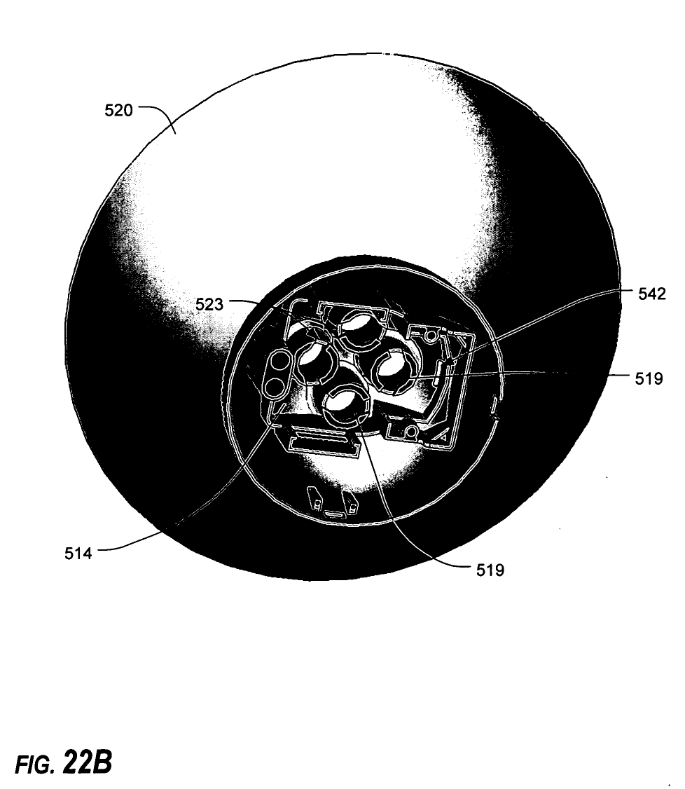

FIGS. 10A-22B set forth a bubble fountain 510 in accordance with another preferred embodiment of the present invention. As shown therein, the bubble fountain 510 includes a base 512, a soap holder 514, a pump 516, a plurality of tubular columns 518 and a catch basin 520. As perhaps best shown in FIGS. 10A-15, the bubble fountain 510 may be configured to have a plurality of tubular columns 518 extending upward and configured to emit bubbles created by the bubble fountain 510. The tubular columns 518 are each seated in a socket 519 (perhaps best shown in FIGS. 22A and 22B) in the bottom of the base 512.

The upper end of each tubular column 518 includes a bubble opening 546 at the top of the bubble fountain 510. In this regard, bubbles created by the bubble fountain 510 eventually reach the top of the tubular columns 518 and escape via the bubble openings 546. Additionally, each of the tubular columns 518 may be arranged in a non-vertical or non-linear orientation so as to permit the bubbles emitting therefrom to be projected in a desired direction. In this regard, non-vertical orientation of the tubular columns 518 may provide enhanced distribution of bubbles to the periphery of the bubble fountain 510. As shown in FIGS. 10A-15, each of the tubular columns 518 is oriented in a direction such that the bubble openings 546 emit bubbles away from the center of the bubble fountain 510. Arrangement of the tubular columns 518 in this non-vertical orientation may facilitate a relatively even distribution of bubbles.

As further shown in FIGS. 10A-15, each of the tubular columns 518 may be configured to have a bulbous portion 550 at the upper end thereof adjacent the bubble opening 546. Bubbles may collect in the bulbous portion 550 of the tubular columns 518 prior to escaping from the bubble fountain 510. In particular, the bubble opening 546 may be smaller than the cross-section of the bulbous portion 550 of each tubular column 518. As bubbles are collected in the bulbous portion 550 and, subsequently, are forced through the smaller bubble opening 546, bubbles are emitted from the tubular columns 518 with greater force. With greater force, the bubbles emitted from the tubular columns 518 may be projected a slightly greater distance from the tubular columns 518, thereby enhancing the distribution of the bubbles.

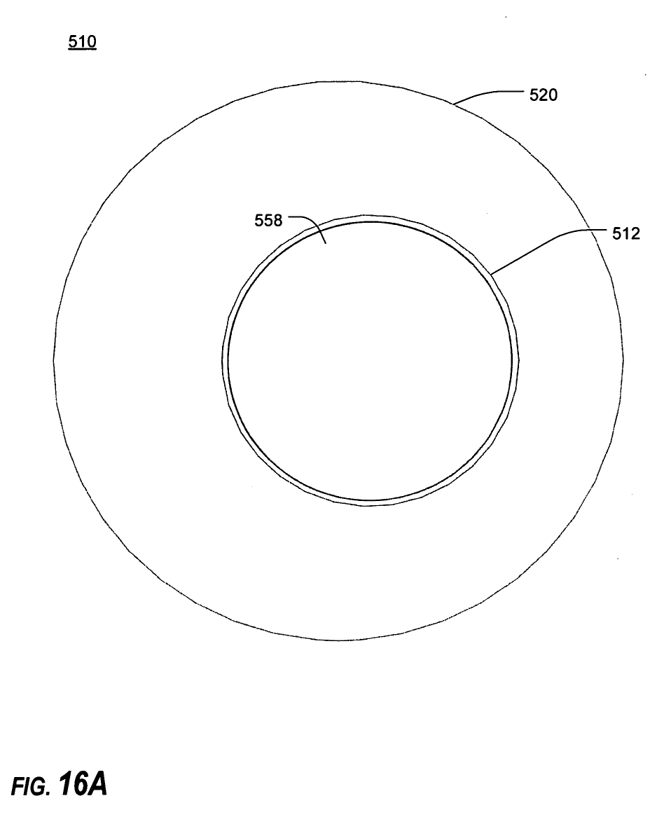

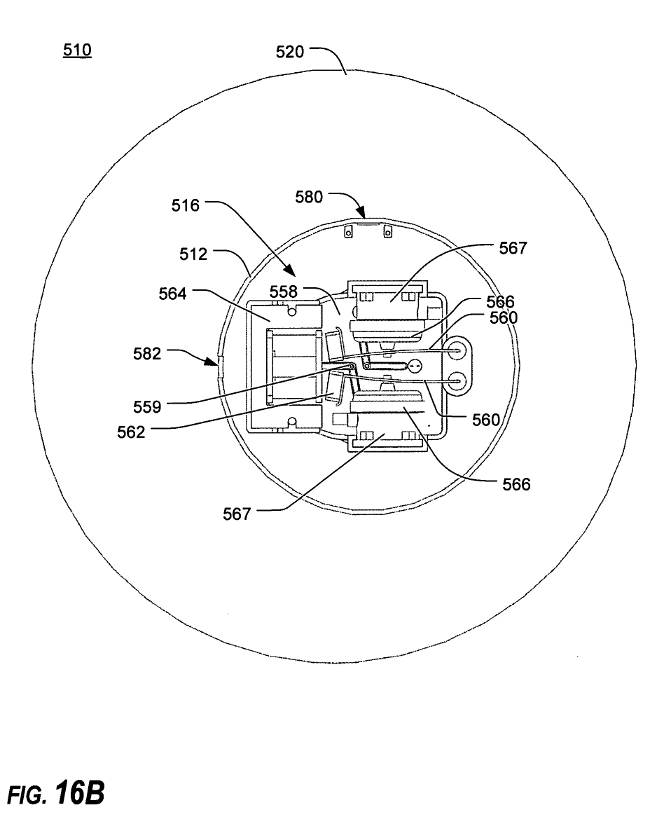

As still further shown in FIGS. 10A-15, a catch basin 520 may be slightly offset with respect to a base 512 and the tubular columns 518. The tilted configuration of the catch basin 520 may also provide a different appearance in a bubble sculpture (not shown) created by the bubble fountain 510. The catch basin 520 may be formed integrally with the base 512, or the catch basin 520 and the base 512 may be formed as separate components. The bottom of the base 512 may be covered by a base cover 528, shown for example in FIG. 16A, that is preferably removable in order to provide access to the pump 516 or other components disposed therein.

As shown in FIGS. 16B-21B, the pump 516 is preferably a double-diaphragm pump that is disposed within the base 512 and is protected from the interior of the catch basin 520 by a seal panel 558. In this regard, each portion of the double-diaphragm pump 516 may function independently of the other. Moreover, each portion of the double-diaphragm pump 516 may be configured to correspond with different tubular columns 518 of the bubble fountain 510.

The pump 516 includes a field coil 564 that uses AC power to charges and discharge, thereby causing magnets 562, each mounted at the end of a flexible arm 560, to vibrate back and forth. The vibration is translated from the magnets 562 through the flexible arms 560 to a pair of diaphragms 566, attached to the arms 560 via a fitting. Each diaphragm 560 thus vibrates, causing air to be pumped from a respective chamber 567 through a section of flexible tubing (not shown) to an inlet 559 attached to or molded in the bottom of the seal panel 558. In particular, in at least one embodiment, the seal panel 558 may be molded from ABS plastic and the inlet 559 may be attached to the seal panel 558 by ABS bonding. Each inlet includes one inlet port and two outlet ports, with each outlet port extending upward into the bottom of a respective socket 519 and thus into the bottom of a respective tubular column 518. Each outlet port is connected to its inlet port by a channel. Because there are two inlets, there are thus a total of four outlet ports, one in the bottom of each tubular column.

In at least some embodiments, the pump 516 uses an electrical motor that may be plugged into a standard wall outlet, but other embodiments may utilize battery- or hand-operated pumps.

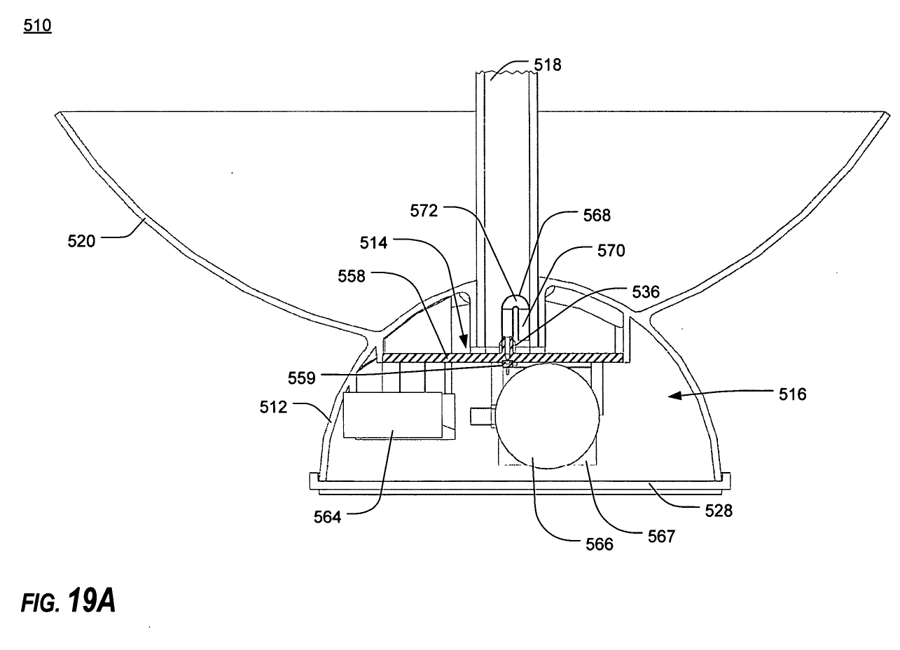

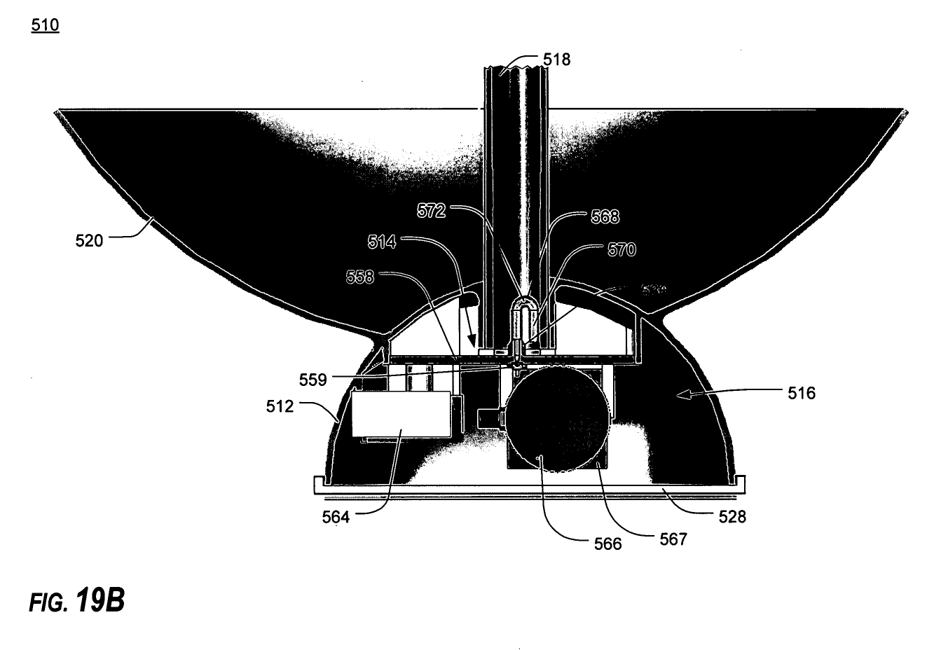

The inlet 559 is in fluid connection with an inverted J-shaped tube 568 that empties into the bottom of the soap holder 514 from the short arm 570 thereof, perhaps best seen in FIGS. 19A and 19B. The bent portion 572 of the J-shaped tube 568 is configured to remain above the surface of the liquid. In this regard, the J-shaped tube 568 acts as a stop to prevent liquid from re-entering the pump 516.

The soap holder 514 is a chamber formed by interior surfaces of the upper portion of the base 512 (perhaps best seen in FIGS. 22A and 22B) and the top surface of the seal panel 558. A pair of notches 523 near the bottom of each of the sockets 519 allows fluid in the soap holder 514 to flow into the bottom of each socket 519 and thus the bottom of each tubular column 518. Each tubular column 518 rests on a ledge, seen in FIGS. 22A and 22B, around the periphery of each socket 519, thus separating the bottom of each tubular column 518 from the top surface of the seal panel 558. The soap-and-water mixture flows from the interior of the catch basin 520 into the soap holder 514 through a slot 542 in the edge thereof. It will be appreciated that additional slots or other openings (not illustrated) may likewise or alternatively be provided for this purpose.

In at least some embodiments, one or more lights 536 such as light emitting diodes (LEDs) or the like may be provided. In a preferred arrangement, one LED 536 is located in the bottom of each socket 519 so as to light each tubular column 518 from the inside. If desired, the LEDs 536 may be of a type whose color varies periodically, thus providing an enhanced lighting effect.

One opening 580 in the side of the base 512 may be provided for a control switch (not shown). Another opening 582 in the bottom rim of the base 512 may be provided for a power cord (not shown).

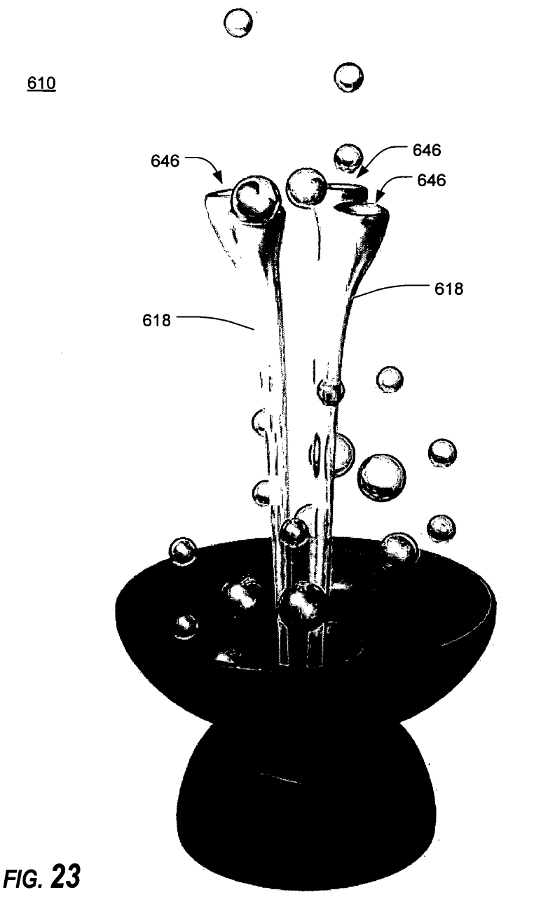

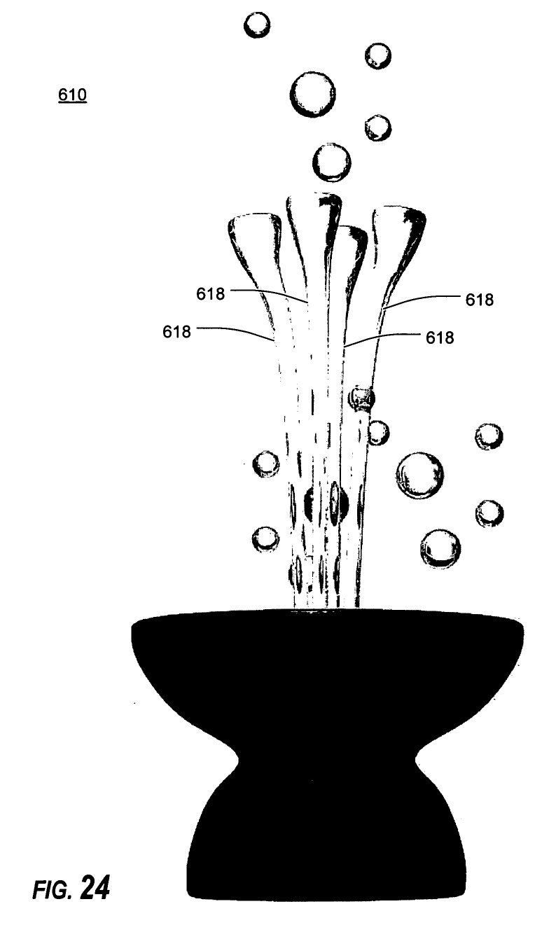

FIGS. 23 and 24 are front perspective views of a bubble fountain 610 in accordance with another preferred embodiment of the present invention. As shown therein, the bubble fountain 610 has a plurality of tubular columns 618 extending upward and configured to emit bubbles created by the bubble fountain 610. The tubular columns 618 may be configured to have any particular shape that might be desired. In particular, as shown in FIGS. 23-24, each tubular column 618 may be configured to have an increasing width along the length thereof that opens at a corresponding bubble opening 646 at the top thereof. Additionally, each of the tubular columns 618 may be arranged in a non-vertical orientation so as to enhance the distribution of bubbles from the bubble fountain 610. Further still, any quantity of tubular columns may be arranged to distribute bubbles, as might be preferred. As shown in FIGS. 23-24, four tubular columns 618 are arranged.

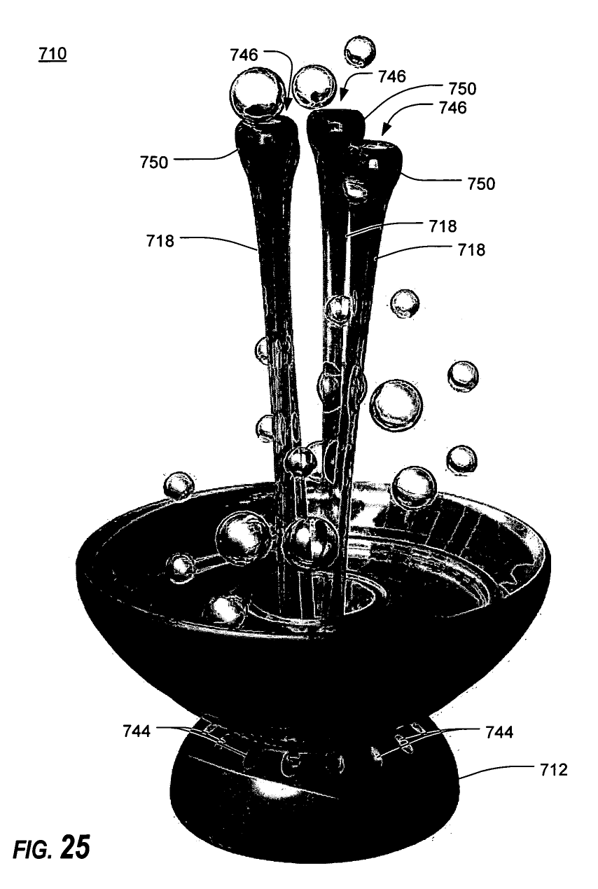

FIG. 25 is a front perspective view of a bubble fountain 710 in accordance with another preferred embodiment of the present invention. As shown therein, the bubble fountain 710 has a plurality of tubular columns 718 extending upward and configured to emit bubbles created by the bubble fountain 710. The upper end of each tubular column 718 is open to provide bubble openings 746 at the top of the bubble fountain 710. In this regard, bubbles created by the bubble fountain 710 eventually reach the top of the tubular columns 718 and escape via the bubble openings 746. Additionally, each of the tubular columns 718 may be arranged in a non-vertical orientation so as to permit the bubbles emitting therefrom to be projected in a desired direction. Orientation of the individual tubular columns 718 may vary, and individual columns of the bubble fountain 710 may be arranged to have varied angles of orientation or tilt. Selection of a particular orientation may assist in distributing bubbles in a particular pattern that might be preferred. As shown in FIG. 25, each of the tubular columns 718 is arranged to have a different orientation or tilt.

As further shown in FIG. 25, each of the tubular columns 718 may be configured to have a bulbous portion 750 at the upper end thereof adjacent the bubble opening 746. Bubbles may collect in the bulbous portion 750 of the tubular columns 718 prior to escaping from the bubble fountain 710. In particular, the bubble opening 746 may be smaller relative to the bulbous portion 750 of each tubular column 718. As bubbles are collected in the bulbous portion and, subsequently, are forced through the smaller bubble opening 746, bubbles are emitted from the tubular columns 718 with greater force. With greater force, the bubbles emitted from the tubular columns 718 may be projected a slightly greater distance from the tubular columns 718, thereby enhancing the distribution of the bubbles.

As still further shown in FIG. 25, the bubble fountain 710 may be configured to have one or more lights 744 to provide the bubble fountain 710 with various lighting effects in a bubble sculpture created by the bubble fountain 710. The lights 744 may be configured in any manner that might be preferred and may be powered by batteries or an electrical source (not shown). As shown in FIG. 25, the lights 744 are configured to emanate from the base 712 of the bubble fountain 710. Additionally, the lights 744 may be arranged in any manner that might be preferred. As shown in FIG. 25, the lights 744 are arranged to be relatively evenly spaced along the upper portion of the base 712 to direct lighting effects upward toward a bubble sculpture. Any type of light source may be utilized in connection with the lights 744. In at least one embodiment, the light source corresponding to each light 744 is a light emitting diode (LED).

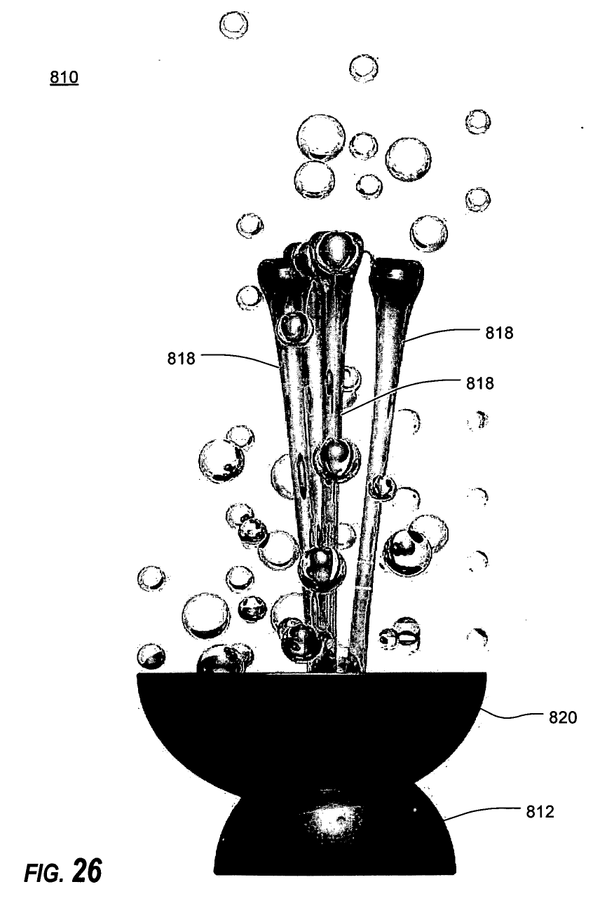

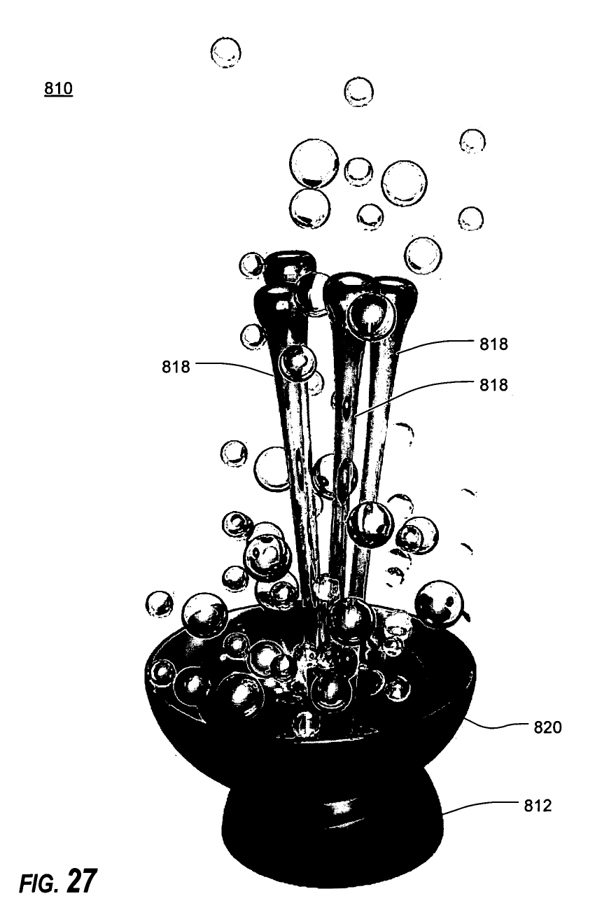

FIGS. 26 and 27 are front perspective views of a bubble fountain 810 in accordance with another preferred embodiment of the present invention. As shown therein, the bubble fountain 810 may be configured to have an offset appearance. In particular, a catch basin 820 may be slightly tilted so as to appear offset with respect to a base 812 and a tubular column 818. The tilted configuration of the catch basin 820 may also provide a different appearance in a bubble sculpture created by the bubble fountain 810.

In accordance with each of the foregoing embodiments, it is further contemplated that an end cap (not shown) may provided at the upper end of one or more of the tubular columns 18,118,218,318,418,518,618,718,818. In at least some embodiments, the end caps are removable and are fitted to attach to the tubular columns. Either type of end cap may further shift or shape the bubbles emitted from the bubble fountain 10,110,210,310,410,510,610,710,810. In particular, it is contemplated that end caps may have varying configurations or varying arrangements of holes so as to funnel, fan or otherwise move the emitted bubbles in a desired manner. As can be appreciated by the Ordinary Artisan, end caps fitted at one or more of the tubular columns 18,118,218,318,418,518,618,718,818 may be interchangeable such that a user of the bubble fountain may select and fit a particular end cap in order to alter the resulting bubble sculpture.

Based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to its preferred embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a generic and descriptive sense only and not for the purpose of limitation.

1. A method of interacting with a soap bubble fountain, having at least one tubular column extending above a catch basin and provided with a sculpting tool, comprising the steps of:
(a) generating soap bubbles with the soap bubble fountain;
(b) actuating an air source to force the bubbles from an upper end of the at least one tubular column;
(c) repeating steps (a) and (b) at least until a bubble sculpture is formed between the upper end of the at least one tubular column and the catch basin; and
(d) sculpting the bubble sculpture using the sculpting tool.

2. The method of claim 1, wherein the air source is an air pump.

3. The method of claim 2, wherein the air pump is battery-operated.

4. The method of claim 2, wherein the air pump is operated by an electrical motor.

5. The method of claim 2, wherein the air pump is a double-diaphragm pump.

6. The method of claim 1, further comprising the step of actuating one or more light sources to provide a lighting effect in the collected bubbles.

7. The method of claim 6, wherein each light source includes a light emitting diode (LED).

8. The method of claim 7, wherein the LEDs are configured to emanate from a base portion of the bubble fountain.

9. The method of claim 7, wherein the LEDs are arranged generally beneath the tubular column.

10. The method of claim 1, wherein the at least one tubular column is flared at the upper end thereof.

11. The method of claim 1, wherein the at least one tubular column has a non-vertical orientation.

12. The method of claim 1, wherein the at least one tubular column has a non-uniform width.

13. The method of claim 1, wherein the at least one tubular column has a bulbous portion at the upper end thereof.

14. The method of claim 1, wherein the bubble fountain is configured to have the shape of a bottle.

15. The method of claim 1, wherein the bubble fountain is configured to have the shape of a dragon.

16. A method of interacting with a soap bubble fountain, having a plurality of tubular columns extending above a catch basin in a non-vertical orientation and provided with a sculpting tool, comprising the steps of:
(a) generating soap bubbles with the soap bubble fountain;
(b) actuating an air source to force the bubbles from an upper end of the at least one tubular column;
(c) repeating steps (a) and (b) at least until a bubble sculpture is formed between the upper end of the at least one tubular column and the catch basin;
(d) sculpting the bubble sculpture using the sculpting tool; and
(e) actuating one or more light sources to provide a lighting effect in the bubble sculpture.

17. The method of claim 16, wherein at least one of the tubular columns is flared at the upper end thereof.

18. The method of claim 16, wherein at least one of the tubular columns has a bulbous portion at the upper end thereof.

19. The method of claim 16, wherein each of the plurality of tubular columns has a different tilt angle.

20. The method of claim 16, wherein soap bubbles are distributed among the plurality of tubular columns.
